(19) United States
(12) Patent Application Publication
(10) Pub. No.: US 2024/0105950 A1
(43) Pub. Date: Mar. 28, 2024

(54) LITHIUM-SULFUR SECONDARY BATTERY ELECTRODE BINDER AND USE THEREOF

(71) Applicant: TOAGOSEI CO., LTD., Tokyo (JP)

(72) Inventor: Naohiko SAITO, Nagoya-shi (JP)

(73) Assignee: TOAGOSEI CO., LTD., Tokyo (JP)

(21) Appl. No.: 18/266,716

(22) PCT Filed: Dec. 2, 2021
(86) PCT No.: PCT/JP2021/044179

§ 371 Date: Jun. 12, 2023

(30) Foreign Application Priority Data
Dec. 16, 2020 (JP) 2020-208753

(51) Int. Cl. H01M 4/62; H01M 4/13; H01M 4/38; H01M 10/0525

(52) U.S. Cl. CPC H01M 4/622; H01M 4/13; H01M 4/38; H01M 10/0525; H01M 2004/028

(57) ABSTRACT

A lithium-sulfur secondary battery electrode binder in which coating properties of an electrode mixture layer composition (electrode slurry) are good, even in a state where the solids concentration of the electrode slurry is high, and which allows increasing the productivity of a secondary battery electrode through an increase in a drying efficiency of the electrode slurry, and increasing significantly the settling stability of the electrode slurry. A binder for a lithium-sulfur secondary battery electrode includes a carboxyl-group-containing polymer or a salt thereof. The carboxyl-group-containing polymer includes a structural unit derived from an ethylenic unsaturated carboxylic acid monomer (A) and a structural unit derived from an ethylenic unsaturated monomer (B) (excluding monomers classified as (A)), and the ethylenically unsaturated monomer (B) has a solubility of 10 g or less in 100 g of water at 20° C.

### TECHNICAL FIELD

The present teaching relates to a lithium-sulfur secondary battery electrode binder, a lithium-sulfur secondary battery electrode mixture layer composition, and a lithium-sulfur secondary battery electrode.

### BACKGROUND ART

Various power storage devices such as nickel-metal hydride secondary batteries, lithium-ion secondary batteries and electric double-layer capacitors are in practical use as secondary batteries.

Among the foregoing, lithium-ion secondary batteries are used in a wide range of applications by virtue of the high energy density and high battery capacity that such batteries afford. Lithium-sulfur secondary batteries that utilize, as a positive electrode active material, a sulfur-based active material, in place of a transition metal oxide such as lithium cobaltate, and that are used in lithium-ion secondary batteries have attracted attention in recent years.

A lithium-sulfur secondary battery basically includes a positive electrode, a negative electrode, and an electrolyte, similarly to lithium-ion batteries, such that charge and discharge are elicited by movement of lithium ions across the electrodes via the electrolyte. Sulfur, which is used as a positive electrode active material in lithium-sulfur secondary batteries, exhibits a very high theoretical capacity density of 1672 mAh/g, and thus lithium-sulfur secondary batteries are expected to be high-capacity batteries.

In a lithium-sulfur secondary battery, on the other hand, sulfur undergoes conversion derived from a stepwise reduction reaction during discharge, and lithium polysulfide (LiSx), which is generated as a result, dissolves readily into the electrolyte solution. In consequence, lithium-sulfur secondary batteries suffer from problems of low cycle characteristics and short life. Another factor underlying the short life of lithium-sulfur secondary batteries is, for instance, a large change in volume that sulfur undergoes at the time of charge and discharge, such that an electrode mixture layer, for instance, peels or sloughs off with repeated use, which translates into a drop in in battery capacity.

Attempts to solve this problem in recent years have involved the use of binders.

Patent Literature 1 discloses an acrylic binder for a lithium-sulfur secondary battery positive electrode, including a polymerization unit of a polymerizable monomer having a polar functional group (one or more types selected from among a nitrogen-containing functional group, an alkylene oxide group a hydroxy group and an alkoxysilyl group) that interacts with a positive electrode active material.

Patent Literature 2 discloses an acrylic binder for a positive electrode of a lithium-sulfur secondary battery, containing a polymerization unit of a first polymerizable monomer having a polar functional group (one or more types selected from the group consisting of an amide group, a nitrile group, and an alkylene oxide group) that interacts with a positive electrode active material, and a polymerization unit of a second polymerizable monomer having a crosslinkable functional group (one or more types selected from the group consisting of an amide group, a nitrile group and an alkylene oxide group).

Patent Literature 3 discloses a binder for producing a positive electrode of a lithium-sulfur secondary battery, the binder containing an acrylic polymer that contains 30 wt % or more of an acrylic-based monomer polymerization unit, and a non-acrylic-based monomer polymerization unit and a redox monomer polymerization unit.

### CITATION LIST

Patent Literature 1: WO 2017/074004
Patent Literature 2: WO 2018/056782
Patent Literature 3: WO 2019/022359

### SUMMARY

### Technical Problem

The positive electrode of a lithium-sulfur secondary battery is generally produced by coating a collector surface with a composition (hereafter also referred to as “electrode slurry”) that is for forming an electrode mixture layer and that contains, for instance, a sulfur active material, a binder and a medium, and by removing then the medium. Water can be preferably used as the medium for the electrode slurry, from the viewpoint of environmental load reduction.

Studies by the inventors have revealed that when water is used as a medium, sulfur does not disperse readily in the electrode slurry, on account of hydrophobicity of sulfur; this is problematic, in terms of coating properties, because roughness and pinholes in a coating film occur in a case where sulfur is present in the form of aggregates in the electrode slurry.

The sulfur active material can be caused to disperse satisfactorily, and a coating film free of roughness and pinholes can be produced, in a case where carboxymethyl cellulose (CMC), which is often used as a thickener for lithium-ion secondary batteries, is utilized in the binder; however, sulfur has insufficient dispersibility, and hence a solids concentration of the electrode slurry needs to be lowered, in order to achieve good coating properties of the electrode slurry. Production of a secondary battery electrode is therefore problematic from the viewpoint of productivity, since a large amount of water is to be evaporated during drying, and efficient drying is thus difficult.

Although the binders disclosed in Patent Literature 1 to 3 also afford good cycle characteristics, the above-described problems pertaining to coating properties and productivity have virtually not been addressed, and improvements are called for.

In the binders disclosed in Patent Literature 1 to 3, moreover, the sulfur active material readily settles upon prolonged storage of the electrode slurry, and improvements as regards settling stability as well are necessary.

It is an object of the present teaching, arrived at in view of the above considerations, to provide a lithium-sulfur secondary battery electrode binder in which coating properties of an electrode mixture layer composition (electrode slurry) are good, even in a state where the solids concentration of the electrode slurry is high, and which allows increasing the productivity of a secondary battery electrode through an increase in a drying efficiency of the electrode slurry, and increasing significantly the settling stability of the electrode slurry. A further object of the present teaching is to provide a lithium-sulfur secondary battery electrode mixture layer composition and a lithium-sulfur secondary battery electrode that are obtained by using the above binder.

### Solution to Technical Problem

As a result of diligent research aimed at solving the above problems, the inventors have found that when a carboxyl group-containing polymer includes a structural unit derived from an ethylenically unsaturated monomer having water solubility not higher than a specific value, good coating properties are achieved in an electrode mixture layer composition (electrode slurry) even in a state where the solids concentration for the electrode slurry is high, and it becomes possible to increase the productivity of a secondary battery electrode through an increase in the drying efficiency of the electrode slurry and increase significantly the settling stability of the electrode slurry.

The present teaching is as follows.
[1] A lithium-sulfur secondary battery electrode binder comprising a carboxyl group-containing polymer or salt thereof,
   wherein the carboxyl group-containing polymer contains a structural unit derived from an ethylenically unsaturated carboxylic acid monomer (A) and a structural unit derived from an ethylenically unsaturated monomer (B) (excluding monomers classified as (A)), and the ethylenically unsaturated monomer (B) has a solubility of 10 g or less in 100 g of water at 20° C.
[2] The lithium-sulfur secondary battery electrode binder according to [1], wherein the carboxyl group-containing polymer contains from 1.0 mass % to 50 mass % of the structural unit derived from the ethylenically unsaturated monomer (B) with respect to all the structural units of the carboxyl group-containing polymer.
[3] The lithium-sulfur secondary battery electrode binder according to [1] or [2], wherein the carboxyl group-containing polymer contains from 50 mass % to 99.9 mass % of the structural unit derived from the ethylenically unsaturated carboxylic acid monomer (A) with respect to all the structural units of the carboxyl group-containing polymer.
[4] The lithium-sulfur secondary battery electrode binder according to any one of [1] to [3], wherein the carboxyl group-containing polymer is a crosslinked polymer.
[5] The lithium-sulfur secondary battery electrode binder according to [4], wherein the crosslinked polymer is a crosslinked polymer obtained through polymerization of a monomer composition that includes a non-crosslinkable monomer and a crosslinkable monomer.
[6] The lithium-sulfur secondary battery electrode binder according to [5], wherein a use amount of the crosslinkable monomer is from 0.1 mol % to 2.0 mol % with respect to a total amount of the non-crosslinkable monomer.
[7] The lithium-sulfur secondary battery electrode binder according to [5] or [6], wherein the crosslinkable monomer contains a compound having two or more allyl ether groups in the molecule.
[8] The lithium-sulfur secondary battery electrode binder according to any one of [4] to [7], wherein a particle diameter of the crosslinked polymer or salt thereof, measured in an aqueous medium after neutralization to a degree of neutralization from 80 to 100 mol %, is from 0.1 μm to 7.0 μm as a volume-based median diameter.
[9] The lithium-sulfur secondary battery electrode binder according to any one of [1] to [8], which is used for producing a positive electrode of a lithium-sulfur secondary battery.
[10] A lithium-sulfur secondary battery electrode mixture layer composition, comprising: the lithium-sulfur secondary battery electrode binder of any one of [1] to [9], an active material, and water.
[11] The lithium-sulfur secondary battery electrode mixture layer composition of [10], wherein the active material contains elemental sulfur or a sulfur-based compound.
[12] A lithium-sulfur secondary battery electrode, comprising, on a collector surface, a mixture layer formed from the secondary battery electrode mixture layer composition of [10] or [11].

### Advantageous Effects

The lithium-sulfur secondary battery electrode binder of the present teaching allows providing a lithium-sulfur secondary battery in which coating properties is ensured even in a state where the solids concentration of the electrode slurry is high, and the drying efficiency of an electrode mixture layer composition (electrode slurry) can be improved and productivity increased, and the settling stability of the electrode slurry can be significantly increased: as a result, the battery exhibits excellent cycle characteristics.

### DESCRIPTION OF EMBODIMENTS

The lithium-sulfur secondary battery electrode binder of the present teaching comprises a carboxyl group-containing polymer or salt thereof, and is mixed with an active material and water, to thereby form a lithium-sulfur secondary battery electrode mixture layer composition. From the viewpoint of bringing out the effect of the present teaching, the above composition is preferably an electrode slurry, in a slurry state, that can be applied to the surface of a collector; however, the composition may be prepared in the state of a wet powder, such that the composition can be pressed against the surface of the collector. The lithium-sulfur secondary battery electrode of the present teaching can be obtained by forming an electrode mixture layer, in turn formed out of the above composition, on the surface of a collector such as a copper foil or aluminum foil.

A lithium-sulfur secondary battery electrode binder, as well as a lithium-sulfur secondary battery electrode mixture layer composition, a lithium-sulfur secondary battery electrode and a lithium-sulfur secondary battery, of the present teaching, and are obtained using the binder, will be explained in turn hereafter in detail.

In the present specification, a term “(meth)acrylic” denotes acrylic and/or methacrylic, and a term “(meth)acrylate” denotes acrylate and/or methacrylate. The term “(meth)acryloyl group” denotes an acryloyl group and/or a methacryloyl group.

1. Binder

The binder of the present teaching contains a carboxyl group-containing polymer (hereafter also referred to as “the polymer”) or a salt thereof, such that the carboxyl group-containing polymer includes a structural unit derived from an ethylenically unsaturated carboxylic acid monomer (A), and a structural unit derived from an ethylenically unsaturated monomer (B) (excluding monomers classified as (A)) having a solubility in 100 g of water at 20° C. of 10 g or less.

1-1. Structural Units of the Carboxyl Group-Containing Polymer

<Structural Unit Derived from the Ethylenically Unsaturated Carboxylic Acid Monomer (A)>

The polymer has a structural unit (hereafter also referred to as “component (a)”) derived from the ethylenically unsaturated carboxylic acid monomer (A), and that can be introduced into the polymer through precipitation polymerization or dispersion polymerization of monomer components that include an ethylenically unsaturated carboxylic acid monomer. By having such a structural unit, the polymer has accordingly carboxyl groups, and in consequence adhesiveness to a collector is enhanced, and also a lithium ion desolvation effect and ion conductivity are excellent, so that an electrode is obtained as a result that has low resistance and boasts excellent high-rate characteristics. In a case where the polymer is a crosslinked polymer, moreover, the polymer can be imparted with water swellability, which translates as a result for instance into improved settling stability of an active material in the composition.

The above component (a) can be introduced into the polymer for instance through polymerization of a monomer that includes the ethylenically unsaturated carboxylic acid monomer (A). Alternatively, component (a) can be obtained through (co)polymerization of a (meth)acrylic acid ester monomer, followed by hydrolysis. Other methods may involve polymerizing for instance (meth)acrylamide and (meth)acrylonitrile, followed by a treatment with a strong alkali, or causing an acid anhydride to react with a polymer having hydroxyl groups.

Examples of the ethylenically unsaturated carboxylic acid monomerinclude (meth)acrylic acid, itaconic acid, crotonic acid, maleic acid and fumaric acid; (meth)acrylamido alkylcarboxylic acids such as (meth)acrylamidohexanoic acid and (meth)acrylamidododecanoic acid; and carboxyl group-containing ethylenically unsaturated monomers such as monohydroxyethyl succinate (meth)acrylate and ω-carboxycaprolactone mono(meth)acrylate, (3-carboxyethyl (meth)acrylate and (partially) alkali neutralized products of these, and one of these alone or a combination of two or more may be used. Of these, a compound having acryloyl groups as polymerizable functional groups is preferred because the rapid polymerization speed produces a polymer with a long primary chain length and a binder with good binding strength, and acrylic acid is especially preferred. A polymer with a high carboxyl group content can be obtained by using acrylic acid as an ethylenically saturated carboxylic acid monomer.

The content of component (a) in the polymer is not particularly limited, but may be for instance from 50 mass % to 99.0 mass % with respect to all the structural units of the polymer. Excellent adhesiveness to the collector can be easily secured by incorporating component (a) within the above range. A lower limit is for instance 55 mass % or higher, or for instance 60 mass % or higher, or for instance 65 mass % or higher. Preferably, the lower limit is 50 mass % or higher, since in that case the settling stability of the composition improves, and a higher binding strength can be achieved; the lower limit may also be 60 mass % or higher, 70 mass % or higher, or 75 mass % or higher. The upper limit may be for instance 99.0 mass % or lower, or for instance 98 mass % or lower, or for instance 96 mass % or lower, or for instance 94 mass % or lower, or for instance 92 mass % or lower, or for instance 90 mass % or lower, or for instance 85 mass % or lower. The range of the content of component (a) can be set to an appropriate combination of such lower limits and upper limits.

<Structural Unit Derived from an Ethylenically Unsaturated Monomer (B)>

The polymer has a structural unit (hereafter also referred to as “component (b)”) derived from an ethylenically unsaturated monomer (B) (excluding monomers classified as (A)) having a solubility in 100 g of water at 20° C. (hereafter also referred simply to as “water solubility”) of 10 g or less.

By virtue of the fact that the polymer has component (b), it becomes possible to bring out strong interactions with electrode materials and good binding ability towards the active material. As a result, the settling stability of the electrode slurry can be improved, and an electrode mixture layer that is firm and well integrated can be obtained.

From the viewpoint of achieving excellent settling stability of the electrode slurry the above water solubility is preferably 8 g or less, more preferably 6 g or less, yet more preferably 4 g or less, still more preferably 2 g or less, even yet more preferably 1 g or less, and even still more preferably 0.5 g or less.

Ethylenically unsaturated monomers (B) include alkyl (meth)acrylates, aromatic (meth)acrylates, styrenes, and aliphatic conjugated diene monomers.

Preferred among the foregoing, from the viewpoint of achieving an excellent settling stability of the electrode slurry, are alkyl (meth)acrylates and aromatic (meth)acrylates, particularly preferably alkyl (meth)acrylates, and preferably alkyl (meth)acrylates having an alkyl group that has four or more carbon atoms.

Alkyl (meth)acrylates include aliphatic alkyl (meth)acrylates and alicyclic alkyl (meth)acrylates.

Examples of aliphatic alkyl (meth)acrylates include methyl (meth)acrylate, ethyl (meth)acrylate, n-butyl (meth)acrylate, isobutyl (meth)acrylate and 2-ethylhexyl (meth)acrylate, and examples of alicyclic alkyl (meth)acrylates include cyclopentyl (meth)acrylate, cyclohexyl (meth)acrylate, methylcyclohexyl (meth)acrylate, t-butylcyclohexyl (meth)acrylate, cyclodecyl (meth)acrylate, cyclododecyl (meth)acrylate, isobornyl (meth)acrylate, adamantyl (meth)acrylate, dicyclopentenyl (meth)acrylate, dicyclopentenyloxyethyl (meth)acrylate and dicyclopentanyl (meth)acrylate; the foregoing may be used singly or in combinations of two or more types.

Examples of aromatic (meth)acrylates include phenyl (meth)acrylate, phenylmethyl (meth)acrylate, phenylethyl (meth)acrylate and phenoxyethyl (meth)acrylate; the foregoing may be used singly or in combinations of two or more types.

Examples of styrenes include styrene, α-methylstyrene, β-methylstyrene, vinylxylene, vinylnaphthalene, o-methylstyrene, m-methylstyrene, p-methylstyrene, o-ethylstyrene, m-ethylstyrene, p-ethylstyrene, p-n-butylstyrene, p-isobutylstyrene, p-t-butylstyrene, o-methoxystyrene, m-methoxystyrene, p-methoxystyrene, o-chloromethylstyrene, p-chloromethyl styrene, o-chlorostyrene, p-chlorostyrene, o-hydroxystyrene, m-hydroxystyrene, p-hydroxystyrene and divinylbenzene; the foregoing may be used singly or in combinations of two or more types.

Examples of aliphatic conjugated diene monomers include 1,3-butadiene, and also 2-methyl-1,3-butadiene, 2,3-dimethyl-1,3-butadiene, 2-chloro-1,3-butadiene and the like; the foregoing may be used singly or in combinations of two or more types.

The content of component (b) in the polymer is not particularly limited, but may be for instance from 1 mass % to 50 mass % with respect to all the structural units of the polymer. By incorporating component (b) within the above range it becomes possible to bring out good coating properties and good settling stability of the electrode slurry. The lower limit is for instance 1 mass % or higher, or for instance 3 mass % or higher, or for instance 5 mass % or higher, or for instance 10 mass % or higher. Preferably, the lower limit is 1 mass % or higher, since in that case the settling stability of the electrode slurry is better. The upper limit is for instance 50 mass % or lower, or for instance 40 mass % or lower, or for instance 30 mass % or lower, or for instance 25 mass % or lower. The range of the content of component (b) can be set to an appropriate combination of such lower limits and upper limits.

<Other Structural Units>

Besides component (a) and component (b), the polymer can contain a structural unit (hereafter referred to as component (c)) derived from another ethylenically unsaturated monomer (excluding monomers classified as (A) or (B)) that is copolymerizable with component (a) and component (b). The component (c) is a structural unit derived from a monomer having an ethylenically unsaturated group, other than component (a) and component (b), and may be a structural unit derived from for instance an ethylenically unsaturated monomer having an anionic group other than a carboxyl group, for instance a sulfonic acid group or a phosphoric acid group, or derived from a nonionic ethylenically unsaturated monomer.

These structural units can be introduced through copolymerization of monomers that include an ethylenically unsaturated monomer having an anionic group other than a carboxyl group, for instance a sulfonic acid group or a phosphoric acid group, or a nonionic ethylenically unsaturated monomer.

The proportion of component (c) can be set to range from 0 mass % to 50 mass % with respect to all the structural units of the polymer. The proportion of component (c) may be from 1 mass % to 40 mass %, or from 3 mass % to 30 mass %, or from 5 mass % to 20 mass %, or from 10 mass % to 15 mass %. The range of the content of component (c) can be set to an appropriate combination of such lower limits and upper limits. When the content of component (c) is 1 mass % or higher with respect to all the structural units of the polymer, affinity to the electrolyte solution improves, and as a result an effect of increasing lithium ion conductivity can also be expected to be elicited.

Of those mentioned above, a structural unit derived from a nonionic ethylenically unsaturated monomer is preferred as the component (c) from the standpoint of obtaining an electrode with good bending resistance, and examples of such nonionic ethylenically unsaturated monomers include (meth)acrylamide and (meth)acrylamide derivatives, and ethylenically unsaturated monomers containing hydroxyl groups and the like.

Examples of (meth)acrylamide derivatives include N-alkyl (meth)acrylamide compounds such as isopropyl (meth)acrylamide and t-butyl (meth)acrylamide; N-alkoxyalkyl (meth)acrylamide compounds such as N-n-butoxymethyl (meth)acrylamide and N-isobutoxymethyl meth(acrylamide); and N,N-dialkyl (meth)acrylamide compounds such as dimethyl (meth)acrylamide and diethyl (meth)acrylamide, and one of these alone or a combination of two or more may be used.

Examples of hydroxyl group-containing ethylenically unsaturated monomers include 2-hydroxyethyl (meth)acrylate, 3-hydroxypropyl (meth)acrylate and 4-hydroxybutyl (meth)acrylate; the foregoing may be used singly or in combinations of two or more types.

Other nonionic ethylenically unsaturated monomers include alkoxyalkyl (meth)acrylates such as 2-methoxyethyl acrylate and 2-ethoxyethyl acrylate; the foregoing may be used singly or in combinations of two or more types.

The polymer or salt thereof preferably contains a structural unit derived from a hydroxyl group-containing ethylenically unsaturated monomer, from the viewpoint of improving the cycle characteristics of the obtained lithium-sulfur secondary battery; herein the content of the structural unit is preferably from 1 mass % to 30 mass %, more preferably from 3 mass % to 20 mass %, and yet more preferably from 5 mass % to 15 mass %. The above ranges can be set in the form of an appropriate combination of such lower limits and upper limits.

Of the non-ionic ethylenically unsaturated monomers, a compound having an acryloyl group is preferable because the polymerization rate is faster, resulting in a polymer with a long primary chain length and a binder with good binding ability.

The polymer may also be a salt. The type of salt is not particularly limited, and examples include alkali metal salts such as lithium salts, sodium salts and potassium salts; alkali earth metal salts such as magnesium salts, calcium salts and barium salts; other metal salts such as aluminum salts; and ammonium salts, organic amine salts and the like. Of these, the alkali metal salts and alkaline earth metal salts are preferred because they are unlikely to adversely affect the battery characteristics, and an alkali metal salt is more preferred. A lithium salt is especially desirable for obtaining a low-resistance battery.

1-2. Crosslinked Polymer

### Preferred Embodiments of the Polymer

Preferably, the carboxyl group-containing polymer of the present teaching is a polymer that has a crosslinked structure (hereafter also referred simply to as “the crosslinked polymer”), in terms of ensuring good coating properties of the electrode slurry also at a high solids concentration, in an electrode mixture layer composition containing a binder that contains the polymer, and in terms of bringing out excellent settling stability of the electrode slurry, and better binding performance. The crosslinking method of the crosslinked polymer is not particularly limited, and for instance crosslinking of the polymer can be accomplished in accordance with the methods below.
1) Copolymerization of a crosslinkable monomer
2) Chain transfer to the polymer chain during radical polymerization
3) Crosslinking following synthesis of a polymer having reactive functional groups, and after addition of a crosslinking agent as necessary.

When the polymer has a crosslinked structure, a binder containing the polymer or its salt can have excellent binding strength. Of the above, the method using copolymerization of a crosslinkable monomer is preferred for ease of controlling the degree of crosslinking.

### <Crosslinkable Monomer>

Examples of crosslinkable monomers include polyfunctional polymerizable monomers having two or more polymerizable unsaturated groups, and monomers having self-crosslinkable functional groups such as hydrolyzable silyl groups and the like.

The polyfunctional polymerizable monomers are compounds having two or more polymerizable functional groups such as (meth)acryloyl or alkenyl groups in the molecule, and examples include polyfunctional (meth)acryloyl compounds, polyfunctional alkenyl compounds, and compounds having both (meth)acryloyl and alkenyl groups and the like. One of these compounds may be used alone, or a combination of two or more may be used. Of these, a polyfunctional alkenyl compound is preferable for ease of obtaining a uniform crosslinked structure, and a polyfunctional allyl ether compound having two or more allyl ether groups in the molecule is especially preferable.

Examples of polyfunctional (meth)acryloyl compounds include di(meth)acrylates of dihydric alcohols, such as ethylene glycol di(meth)acrylate, propylene glycol di(meth)acrylate, 1,6-hexanediol di(meth)acrylate, polyethylene glycol di(meth)acrylate and polypropylene glycol di(meth)acrylate; tri(meth)acrylates of trihydric and higher polyhydric alcohols, such as trimethylolpropane tri(meth)acrylate, trimethylolpropane ethylene oxide modified tri(meth)acrylate, glycerin tri(meth)acrylate, pentaerythritol tri(meth)acrylate and pentaerythritol tetra(meth)acrylate; poly(meth)acrylates such as tetra(meth)acrylate and bisamides such as methylene bisacrylamide and hydroxyethylene bisacrylamide and the like.

Examples of polyfunctional alkenyl compounds include polyfunctional allyl ether compounds such as trimethylolpropane diallyl ether, trimethylolpropane triallyl ether, pentaerythritol diallyl ether, pentaerythritol triallyl ether, tetraallyl oxyethane and polyallyl saccharose; polyfunctional allyl compounds such as diallyl phthalate; and polyfunctional vinyl compounds such as divinyl benzene and the like.

Examples of compounds having both (meth)acryloyl and alkenyl groups include allyl (meth)acrylate, isopropenyl (meth)acrylate, butenyl (meth)acrylate, pentenyl (meth)acrylate and 2-(2-vinyloxyethoxy)ethyl (meth)acrylate and the like.

Specific examples of the monomers having self-crosslinkable functional groups include vinyl monomers containing hydrolysable silyl groups, and N-methylol (meth)acrylamide, N-methoxyalkyl (meth)acrylamide and the like. One of these compounds or a mixture of two or more may be used.

The vinyl monomers containing hydrolysable silyl groups are not particularly limited as long as they are vinyl monomers having at least one hydrolysable silyl group. Examples include vinyl silanes such as vinyl trimethoxysilane, vinyl triethoxysilane, vinyl methyl dimethoxysilane and vinyl dimethyl methoxysilane; acrylic acid esters containing silyl groups, such as trimethoxysilylpropyl acrylate, triethoxysilylpropyl acrylate and methyl dimethoxysilylpropyl acrylate; methacrylic acid esters containing silyl groups, such as trimethoxysilylpropyl methacrylate, triethoxysilylpropyl methacrylate, methyl dimethoxysilylpropyl methacrylate and dimethyl methoxysilylpropyl methacrylate; vinyl ethers containing silyl groups, such as trimethoxysilylpropyl vinyl ether; and vinyl esters containing silyl groups, such as vinyl trimethoxysilyl undecanoate and the like.

In a case where the crosslinked polymer is crosslinked using a crosslinkable monomer, a use amount of the crosslinkable monomer is preferably from 0.01 to 5 mol %, more preferably from 0.05 to 2.0 mol %, yet more preferably from 0.1 to 2.0 mol %, still more preferably from 0.1 to 1.0 mol % and even yet more preferably from 0.2 to 0.6 mol %, relative to the total amount of monomers (non-crosslinkable monomer) other than the crosslinkable monomer. The above ranges can be set in the form of an appropriate combination of such lower limits and upper limits. A use amount of the crosslinkable monomer is preferably 0.1 mol % or higher, since that way the binding ability and the settling stability of the electrode slurry are better. Preferably, the use amount is 2.0 mol % or lower, since this translates into better binding ability.

<Particle Diameter of Crosslinked Polymer>

To obtain good binding performance with a binder containing the crosslinked polymer, preferably the crosslinked polymer is present in the electrode mixture layer composition not as large-diameter masses (secondary aggregations) but as well-dispersed water swollen particles of a suitable particle diameter.

Preferably when the crosslinked polymer or salt thereof of the teaching with a degree of neutralization of 80 to 100 mol % based on the carboxyl groups of the crosslinked polymer is dispersed in water, the particle diameter (water swollen particle diameter) thereof is a volume-based median diameter in the range of from 0.1 to 7.0 microns. If the particle diameter is at least 0.1 but not more than 7 microns, the electrode mixture layer composition is highly stable and excellent binding ability can be achieved because the polymer is uniformly present at a suitable size in the electrode mixture layer composition. If the particle diameter exceeds 7.0 microns, binding ability may be insufficient as discussed above. There is also a risk that the coating properties may be inadequate because it is difficult to obtain a smooth coated surface. A particle diameter smaller than 0.1 μm may be problematic from the viewpoint of stable manufacturing. The lower limit of the particle diameter may be 0.2 μm or larger, or 0.3 μm or larger, or 0.4 μm or larger, or 0.5 μm or larger, or 0.6 μm or larger, or 0.7 μm or larger, or 0.8 μm or larger. The upper limit of the particle diameter may be 6.0 μm or smaller, or 5.0 μm or smaller, or 4.0 μm or smaller, or 3.0 μm or smaller, or 2.5 μm or smaller, or 2.0 μm or smaller. The range of particle diameter can be set to an appropriate combination of such lower limits and upper limits.

The water swelled particle diameter can be measured by the methods described in the examples of this Description.

When the crosslinked polymer is not neutralized or is neutralized to a degree of less than 80 mol %, the particle diameter may be measured after it has been neutralized to a degree of 80 to 100 mol % with an alkali metal hydroxide or the like and dispersed in water. In general, crosslinked polymers or their salts in a powder or solution (dispersion) state often exist as bulky particles formed by agglomeration and aggregation of primary particles. If the particle diameter is within the above range when dispersed in water, the crosslinked polymer or salt thereof has extremely good dispersibility, and bulky particles are broken up by being neutralized to a degree of 80 to 100 mol % and dispersed in water to form a stable dispersed state with a particle diameter in the range of from 0.1 to 7.0 microns consisting primarily of dispersed primary particles or secondary aggregates.

A particle size distribution is herein a value resulting from dividing a volume-average particle diameter of water-swollen particles by a number-average particle diameter thereof, and is preferably 2.0 or less, more preferably 1.5 or less, yet more preferably 1.4 or less and still more preferably 1.3 or less, from the viewpoint of binding ability and coating properties. The lower limit of the particle size distribution is ordinarily 1.0.

The particle diameter of the crosslinked polymer or salt thereof of the present teaching when dried (dry particle diameter) ranges preferably from 0.1 μm to 2.0 μm in terms of volume-based median diameter. More preferably, the particle diameter ranges from 0.2 μm to 1.0 μm, and yet more preferably from 0.3 μm to 0.7 μm.

In the electrode mixture layer composition, the crosslinked polymer or salt thereof is preferably used in the form of a salt in which the acid groups such as carboxyl groups derived from the ethylenically unsaturated carboxylic acid monomer have been neutralized to a degree of neutralization of from 20 to 100 mol %. The degree of neutralization is preferably from 50 to 100 mol %, or more preferably from 60 to 95 mol %. A degree of neutralization of at least 20 mol % is desirable for obtaining good water swellability and a dispersion stabilization effect. In this Description, the degree of neutralization can be calculated from the charged values of the monomer having acid groups such as carboxyl groups and the neutralizing agent used for neutralization. The degree of neutralization can be confirmed from the intensity ratio of a peak derived from C═O groups of carboxylic acids and a peak derived from C═O groups of carboxylic acid salts in IR measurement of a powder obtained by drying the crosslinked polymer or salt thereof for 3 hours at 80° C. under reduced pressure.

<Molecular Weight (Primary Chain Length) of Crosslinked Polymer>

The crosslinked polymer has a three-dimensional crosslinked structure and exists as a microgel in media such as water. Because such a three-dimensional crosslinked polymer is normally insoluble in solvents, its molecular weight cannot be measured. Similarly, it is normally difficult to measure or assay the primary chain length of the crosslinked polymer.

<1-3. Method for Manufacturing Polymer or Salt Thereof

A known polymerization method such as solution polymerization, precipitation polymerization, suspension polymerization or emulsion polymerization may be used for the polymer, but precipitation polymerization and suspension polymerization (reverse-phase suspension polymerization) are preferred from the standpoint of productivity. A heterogenous polymerization method such as precipitation polymerization, suspension polymerization or emulsion polymerization is preferred for obtaining good performance in terms of binding ability and the like, and a precipitation polymerization method is especially preferred.

Precipitation polymerization is a method of manufacturing a polymer by performing a polymerization reaction in a solvent that dissolves the starting material (unsaturated monomer) but effectively does not dissolve the resulting polymer. As polymerization progresses, the polymer particles grow larger by aggregation and polymer growth, and a dispersion of secondary polymer particles is obtained, in which primary particles of tens of nanometers to hundreds of nanometers are aggregated to the secondary polymer particles of micrometers to tens of micrometers in size. A dispersion stabilizer may be used to control the particle size of the polymer.

Specific examples of dispersion stabilizers include macromonomer-type dispersion stabilizers, and nonionic surfactants and the like.

Such secondary aggregation can also be suppressed by selecting a dispersion stabilizer, a polymerization solvent and the like. In general, precipitation polymerization in which secondary aggregation is suppressed is also referred to as dispersion polymerization.

In a case of precipitation polymerization, the polymerization solvent may be selected from water and various organic solvents and the like depending on a type of monomer used and the like. To obtain a polymer with a longer primary chain length, it is desirable to use a solvent with a small chain transfer constant.

Examples of the polymerization solvents include water-soluble solvents such as methanol, t-butyl alcohol, acetone, methyl ethyl ketone, acetonitrile and tetrahydrofuran, and benzene, ethyl acetate, dichloroethane, n-hexane, cyclohexane and n-heptane and the like, and one of these or a combination of two or more may be used. Mixed solvents of any of these with water may also be used. In the present teachings, a water-soluble solvent means one having a solubility of more than 10 g/100 ml in water at 20° C.

Of these solvents, acetonitrile and methyl ethyl ketone are preferred because, for example, polymerization stability is good, with less production of coarse particles and adhesion to the reaction vessel, because the precipitated polymer fine particles are less liable to secondary aggregation (or any secondary aggregates that occur are easily broken up in an aqueous medium), because the chain transfer constant is low, resulting in a polymer with a high degree of polymerization (long primary chain length), and because an operation is easier in a process neutralization described below.

It is also desirable to add a small amount of a highly polar solvent to the polymerization solvent in order to promote a stable and rapid neutralization reaction during the same process neutralization. Preferred examples of this highly polar solvent include water and methanol. The amount of the highly polar solvent used is preferably from 0.05 to 20.0 mass %, or more preferably from 0.1 to 10.0 mass %, or still more preferably from 0.1 to 5.0 mass %, or yet more preferably from 0.1 to 1.0 mass % based on the total mass of the medium. If the ratio of the highly polar solvent is at least 0.05 mass % it can have an effect on the neutralization reaction, while if the ratio is not more than 20.0 mass % there are no adverse effects on the polymerization reaction. When polymerizing a highly hydrophilic ethylenically unsaturated carboxylic acid monomer such as acrylic acid, moreover, adding a highly polar solvent serves to increase the polymerization speed, making it easier to obtain a polymer with a long primary chain length. Of the highly polar solvents, water is especially desirable for increasing the polymerization speed.

Production of the polymer or salt thereof preferably includes a polymerization step of polymerizing monomer components that include a structural unit derived from an ethylenically unsaturated carboxylic acid monomer (A) and the ethylenically unsaturated monomer (B). For instance, production of the polymer or salt thereof preferably includes a polymerization step of polymerizing monomer components that include from 50 mass % to 99.0 mass % of the ethylenically unsaturated carboxylic acid monomer (A) that yields component (a), and from 1.0 mass % to 50 mass % of the ethylenically unsaturated monomer (B) that yields component (b).

As a result of the above polymerization step, 50 mass % to 99.0 mass % of a structural unit (component (a)) derived from an ethylenically unsaturated carboxylic acid monomer (A), and 1.0 mass % to 50 mass % of a structural unit (component (b)), derived from an ethylenically unsaturated monomer (B), become introduced into the polymer.

The use amount of the ethylenically unsaturated carboxylic acid monomer (A) is for instance from 50 mass % to 99.0 mass %, or for instance from 60 mass % to 96 mass %, or for instance from 65 mass % to 93 mass %, or for instance from 70 mass % to 90 mass %.

The use amount of the ethylenically unsaturated monomer (B) is for instance from 1.0 mass % to 50 mass %, or for instance from 3 mass % to 40 mass %, or for instance from 5 mass % to 35 mass %, or for instance from 8 mass % to 30 mass %, or for instance from 10 mass % to 30 mass %.

Besides component (a) and component (b), the polymer may contain a structural unit (component (c)) derived from another ethylenically unsaturated monomer that is copolymerizable with the foregoing. Examples of other ethylenically unsaturated monomers that yield component (c) include ethylenically unsaturated monomer compounds having anionic groups other than a carboxyl group, such as a sulfonic acid group and a phosphoric acid group, as well as nonionic ethylenically unsaturated monomers. Examples of concrete such compounds include monomer compounds that allow introducing the above-described component (c). The content of the other ethylenically unsaturated monomer may be from 0 mass % to 50 mass %, or from 1 mass % to 40 mass %, or from 3 mass % to 30 mass %, or from 5 mass % to 20 mass %, or from 10 mass % to 15 mass %, relative to the total amount of the monomer components.

The monomer components that are polymerized in the polymerization step may also include a crosslinkable monomer. As discussed above, examples of crosslinkable monomers include polyfunctional polymerizable monomers having two or more polymerizable unsaturated groups, and monomers having self-crosslinking crosslinkable functional groups, such as hydrolytic silyl groups and the like. Use amounts of crosslinkable monomers are the amounts as disclosed above.

The monomer concentration during polymerization is preferably high from the standpoint of obtaining a polymer with a long primary chain length. However, if the monomer concentration is too high the polymer particles are likely to aggregate, and it becomes difficult to control the polymerization heat, raising the risk of a runaway reaction. For example, in the case of precipitation polymerization the monomer composition at the beginning of polymerization is generally in the range of about 2 to 40 mass %, or preferably from 5 to 40 mass %.

In this Description, the “monomer concentration” is the concentration of monomers in the reaction solution at the polymerization initiation point.

The polymer may also be manufactured by performing a polymerization reaction in the presence of a basic compound. A stable polymerization reaction can be achieved even at a high monomer concentration by performing the polymerization reaction in the presence of a basic compound. The monomer concentration may be at least 13.0 mass %, or preferably at least 15.0 mass %, or more preferably at least 17.0 mass %, or still more preferably at least 19.0 mass %, or yet more preferably at least 20.0 mass %. Still more preferably the monomer concentration is at least 22.0 mass %, or yet more preferably at least 25.0 mass %. In general, the molecular weight can be increased by increasing the monomer concentration during polymerization, yielding a polymer with a long primary chain length. This also tends to reduce the sol fraction of the polymer because a polymer with a long primary chain length is likely to be incorporated into three-dimensional crosslinked structures.

The maximum value of the monomer concentration differs according to the monomers used, the type of solvent, the polymerization method and the various polymerization conditions and the like, but assuming that the polymerization reaction heat can be removed, the maximum value is generally about 40% in the case of precipitation polymerization as discussed above, or about 50% in the case of suspension polymerization, or about 70% in the case of emulsion polymerization.

The basic compound is a so-called alkali compound, and either an inorganic basic compound or an organic basic compound may be used. By performing a polymerization reaction in the presence of a basic compound, it is possible to achieve a stable polymerization reaction even with a high monomer concentration exceeding 13.0 mass % for example. Furthermore, a polymer obtained by polymerization at such a high monomer concentration has excellent binding ability due to having a high molecular weight (long primary chain length).

Examples of inorganic basic compounds include alkali metal hydroxides such as lithium hydroxide, sodium hydroxide and potassium hydroxide, alkali earth metal hydroxides such as calcium hydroxide and magnesium hydroxide, and alkali metal carbonates such as sodium carbonate, potassium carbonate and the like, and one or two or more of these may be used.

Examples of organic basic compounds include ammonia and organic amine compounds, and one or two or more of these may be used. Of these compounds, an organic amine compound is desirable considering polymerization stability and the binding ability of a binder containing the resulting crosslinked polymer or salt thereof.

Examples of organic amine compounds include N-alkyl substituted amines such as monomethylamine, dimethylamine, trimethylamine, monoethylamine, diethylamine, triethylamine, monobutylamine, dibutylamine, tributylamine, monohexylamine, dihexylamine, trihexylamine, trioctylamine and tridodecylamine; (alkyl) alkanolamines such as monoethanolamine, diethanolamine, triethanolamine, propanolamine, dimethylethanolamine and N,N-dimethylethanolamine; cyclic amines such as pyridine, piperidine, piperazine, 1,8-bis(dimethylamino)naphthalene, morpholine and diazabicycloundecene (DBU); and diethylene triamine and N,N-dimethylbenzylamine, and one or two or more of these may be used.

Of these, a hydrophobic amine having long-chain alkyl groups is desirable for ensuring polymerization stability even at a high monomer concentration because it yields greater static repulsion and steric repulsion. Specifically, the higher the value (C/N) of the ratio of the number of carbon atoms relative to the number of nitrogen atoms in the organic amine compound, the greater the polymerization stabilization effect due to steric repulsion. This C/N ratio is preferably at least 3, or more preferably at least 5, or still more preferably at least 10, or yet more preferably at least 20.

The amount of the basic compound used is preferably in the range of from 0.001 mol % to 4.0 mol % of the ethylenically unsaturated carboxylic acid monomer. If the amount of the basic compound is within this range, the polymerization reaction can progress smoothly. The amount used may also be from 0.05 to 4.0 mol %, or from 0.1 to 4.0 mol %, or from 0.1 to 3.0 mol %, or from 0.1 to 2.0 mol %.

In this Description, the amount of the basic compound is represented as the molar concentration of the basic compound relative to the ethylenically unsaturated carboxylic acid compound and does not signify the degree of neutralization. That is, the valence of the basic compound is not considered.

A known polymerization initiator such as an azo compound, organic peroxide or inorganic peroxide may be used as a polymerization initiator, without any particular restrictions. The conditions of use may be adjusted to achieve a suitable amount of radical generation, using a known method such as thermal initiation, redox initiation using a reducing agent, UV initiation or the like. To obtain a crosslinked polymer with a long primary chain length, the conditions are preferably set so as to reduce the amount of radical generation within the allowable range of manufacturing time.

Examples of the azo compound include 2,2′-azobis(2,4-dimethylvaleronitrile), 2,2′-azobis(N-butyl-2-methylpropionamide), 2-(tert-butylazo)-2-cyanopropane, 2,2′-azobis(2,4,4-trimethylpentane) and 2,2′-azobis(2-methylpropane), and one of these or a combination of two or more may be used.

Examples of the organic peroxide include 2,2-bis(4,4-di-t-butylperoxycyclohexyl) propane (product name “Pertetra A” by NOF Corporation), 1,1-di(t-hexylperoxy) cyclohexane (product name “Perhexa HC” by NOF Corporation), 1,1-di(t-butylperoxy) cyclohexane (product name “Perhexa C” by NOF Corporation), n-butyl-4,4-di(t-butylperoxy) valerate (product name “Perhexa V” by NOF Corporation), 2,2-di(t-butylperoxy)butane (product name “Perhexa 22” by NOF Corporation), t-butylhydroperoxide (product name “Perbutyl H” by NOF Corporation), cumene hydroperoxide (product name “Percumyl H” by NOF Corporation), 1,1,3,3-tetramethylbutyl hydroperoxide (product name “Perocta H” by NOF Corporation), t-butylcumyl peroxide (product name “Perbutyl C” by NOF Corporation), di-t-butyl peroxide (product name “Perbutyl D” by NOF Corporation), di-t-hexyl peroxide (product name “Perhexyl D” by NOF Corporation), di(3,5,5-trimethylhexanoyl) peroxide (product name “Peroyl 355” by NOF Corporation), dilauroyl peroxide (product name “Peroyl L” by NOF Corporation), bis(4-t-butylcyclohexyl) peroxydicarbonate (product name “Peroyl TCP” by NOF Corporation), di-2-ethylhexyl peroxydicarbonate (product name “Peroyl OPP” by NOF Corporation), di-sec-butyl peroxydicarbonate (product name “Peroyl SBP” by NOF Corporation), cumyl peroxyneodecanoate (product name “Percumyl ND” by NOF Corporation), 1,1,3,3-tetramethylbutyl peroxyneodecanoate (product name “Perocta ND” by NOF Corporation), t-hexyl peroxyneodecanoate (product name “Perhexyl ND” by NOF Corporation), t-butyl peroxyneodecanoate (product name “Perbutyl ND” by NOF Corporation), t-butyl peroxyneoheptanoate (product name “Perbutyl NHP” by NOF Corporation), t-hexyl peroxypivalate (product name “Perhexyl PV” by NOF Corporation), t-butyl peroxypivalate (product name “Perbutyl PV” by NOF Corporation), 2,5-dimethyl-2,5-di(2-ethylhexanoyl) hexane (product name “Perhexa 250” by NOF Corporation), 1,1,3,3-tetramethylbutylperoxy-2-ethylhexanoate (product name “Perocta O” by NOF Corporation), t-hexylperoxy-2-ethylhexanoate (product name “Perhexyl O” by NOF Corporation), t-butylperoxy-2-ethylhexanoate (product name “Perbutyl O” by NOF Corporation), t-butyl peroxylaurate (product name “Perbutyl L” by NOF Corporation), t-butyl peroxy-3,5,5-trimethylhexanoate (product name “Perbutyl 355” by NOF Corporation), t-hexylperoxyisopropyl monocarbonate (product name “Perhexyl I” by NOF Corporation), t-butylperoxyisopropyl monocarbonate (product name “Perbutyl I” by NOF Corporation), t-butyl-peroxy-2-ethyl hexyl monocarbonate (product name “Perbutyl E” by NOF Corporation), t-butyl peroxyacetate (product name “Perbutyl A” by NOF Corporation), t-hexyl peroxybenzoate (product name “Perhexyl Z” by NOF Corporation) and t-butyl peroxybenzoate (product name “Perbutyl Z” by NOF Corporation) and the like. One of these or a combination of two or more may be used.

Examples of the inorganic peroxide include potassium persulfate, sodium persulfate and ammonium persulfate.

When using a redox initiator, sodium sulfite, sodium thiosulfate, sodium formaldehyde sulfoxylate, ascorbic acid, sulfite gas (SO₂), ferrous sulfate or the like can be used as the reducing agent.

Given 100 mass parts as the total amount of the monomer components used, the polymerization initiator is preferably used in the amount of from 0.001 to 2 mass parts, or from 0.005 to 1 mass part, or from 0.01 to 0.1 mass parts for example. If the amount of the polymerization initiator is at least 0.001 mass parts, a stable polymerization reaction can be achieved, while if it is not more than 2 mass parts it is easy to obtain a polymer with a long primary chain length.

The polymerization temperature depends on the types and concentrations of the monomers used and the like, but is preferably from 0 to 100° C., or more preferably from 20 to 80° C., and the polymerization temperature may be constant or may vary during the period of the polymerization reaction.

The polymer dispersion obtained through the polymerization step may be subjected to a drying step in which the solvent is removed by pressure reduction and/or heating treatment or the like to yield the target polymer in a powder form. In this case, the drying step is preferably preceded by a solid-liquid separation step by centrifugation, filtration or the like and a washing step using water, methanol or the same solvent as the polymerization solvent to remove unreacted monomers (and their salts) and impurities derived from the polymerization initiator and the like after the polymerization step. When such a washing step is included, the polymer breaks up more easily during use even when secondary aggregations have formed, and good performance in terms of binding ability and battery characteristics is also obtained because residual unreacted monomers are removed.

The present production method involves conducting a polymerization reaction of monomer components that include a structural unit derived from an ethylenically unsaturated carboxylic acid monomer (A) and an ethylenically unsaturated monomer (B) excluding monomers classified as (A)) in the presence of a basic compound; however, a solvent may be removed, in a drying step, after neutralization (hereafter also referred to as “process neutralization”) of the polymer, through addition of an alkali compound to a polymer dispersion obtained as a result of the polymerization step. Alternatively, a powder of the polymer may be obtained, without such performing such a process neutralization treatment, after which an alkali compound may be added at the time of preparation of the electrode slurry, to neutralize the polymer (hereafter this is also referred to as “post-neutralization”). Preferred among the above is process neutralization, which tends to yield secondary aggregates that break up more readily.

2. Lithium-Sulfur Secondary Battery Electrode Mixture Layer Composition

The lithium-sulfur secondary battery electrode mixture layer composition of the present teaching contains a binder containing the above polymer or salt thereof, as well as a binder, an active material and water.

In terms of the above active material, elemental sulfur or a sulfur-based compound can be used as the positive electrode active material, while metallic lithium or a lithium alloy can be used as the negative electrode active material. Although the binder according to the present teaching elicits the effect of the present teaching, in particular in terms of producing a positive electrode, the binder may also be used for producing a negative electrode.

The above elemental sulfur or sulfur-based compound may be used singly or in combinations of two or more types. Examples of the sulfur-based compound include Li₂Sn (n≥1), organic sulfur compounds, and carbon-sulfur polymers (C₂Sₓ)ₙ, where x=2.5 to 50, and n≥2).

Metallic lithium or a lithium alloy used as the above negative electrode active material is a substance that can reversibly store or release lithium ions, or a substance that can react with lithium ions to reversibly form a lithium-containing compound.

Examples of the substance capable of reversibly storing and releasing lithium ions include crystalline carbon, amorphous carbon, and mixtures of the foregoing.

Examples of the substance capable of reversibly forming a lithium-containing compound by reacting with lithium ions include tin oxide and silicone.

The lithium alloy may be for instance an alloy of lithium and “a metal selected from the group consisting of sodium, potassium, cesium, francium, beryllium, magnesium, calcium, strontium, barium, radium, aluminum and tin”.

The amount of the polymer or salt thereof used in the electrode mixture layer composition of the present teaching is for example from 0.1 to 20 mass % of the total amount of the active material. This amount used may also be from 0.2 to 10 mass %, or from 0.3 to 8 mass %, or from 0.4 to 5 mass % for example. Adequate binding ability may not be obtained if the amount of the polymer or salt thereof is less than 0.1 mass %. The dispersion stability of the active material and the like may also be inadequate, and the formed mixture layer may be less uniform. If the mount of the polymer or salt thereof exceeds 20 mass %, on the other hand, the coating properties on the collector may decline because the electrode mixture layer composition is too viscous. The resulting mixture layer may have inclusions and irregularities as a result, adversely affecting the battery characteristics.

If the amount of the crosslinked polymer and salt thereof is within the aforementioned range, a composition with excellent settling stability can be obtained, and it is also possible to obtain a mixture layer with extremely high adhesiveness to the collector, resulting in improved battery durability. Moreover, because the polymer and salt thereof has sufficient ability to bind the active material even in a small quantity (such as 5 mass % or less), and because it has carboxy anions, it can yield an electrode with little interface resistance and excellent high-rate characteristics.

Elemental sulfur and sulfur-based compounds have low electrical conductivity, and hence it is commonplace to use the foregoing with a conductive aid added thereto. Examples of conductive aids include carbon-based materials such as carbon black, carbon nanotubes, a graphite fine powder and carbon fibers, and preferably, among the foregoing, carbon black, carbon nanotubes and carbon fibers, in terms of readily achieving excellent conductivity. Ketjen black and acetylene black are preferred as the carbon black. The conductive aid may be used singly as one type among the foregoing, or may be used in combinations of two or more types. From the viewpoint of combining conductivity and energy density, the use amount of the conductive aid can be set to for instance from 0.2 to 20 parts by mass, or for instance from 0.2 to 10 parts by mass, relative to 100 parts by mass as the total amount of the active material. The positive electrode active material may be surface-coated with a conductive carbon-based material.

In a case where the lithium-sulfur secondary battery electrode mixture layer composition is in a slurry state, the use amount of the active material ranges for instance from 10 to 75 mass % relative to the total amount of the composition. If the amount of the active material is at least 10 mass %, migration of the binder and the like is suppressed. Because this is also useful for controlling medium drying costs, the amount of the active material is preferably at least 30 mass %, or more preferably at least 40 mass %, or still more preferably at least 50 mass %. If the amount is not more than 75 mass %, on the other hand, it is possible to ensure good flowability and coating properties of the composition and form a uniform mixture layer.

The lithium-sulfur secondary battery electrode mixture layer composition uses water as a medium. A mixed solvent of water with a lower alcohol such as methanol or ethanol, a carbonate such as ethylene carbonate, a ketone such as acetone, or a water-soluble organic solvent such as tetrahydrofuran or N-methyl-2-pyrrolidone may also be used to adjust the consistency, drying properties and the like of the composition. The percentage of water in the mixed solvent is at least 50 mass % for example or at least 70 mass % for example.

In a case where the lithium-sulfur secondary battery electrode mixture layer composition is brought to a coatable slurry state, the solids concentration thereof is not limited to about 50 mass %, and the content of a medium, including water, in the totality of the composition can be for instance set to range from 25 to 90 mass %, or for instance from 35 to 70 mass %, or for instance from 45 to 70 mass %, from the viewpoint of the coating properties of the electrode slurry, energy cost incurred in drying, and productivity.

The binder of the present teaching may consist only of the polymer or salt thereof, but other binder components such as styrene/butadiene latex (SBR), acrylic latex and polyvinylidene fluoride latex may also be included. When another binder component is included, the amount used may be, for example, from 0.1 to 5 parts by mass, or from 0.1 to 2 parts by mass, or from 0.1 to 1 parts by mass relative to 100 parts by mass as the total amount of the active materials. If more than 5 mass % of the other binder component is used resistance may increase, resulting in inadequate high-rate characteristics. Of the above, styrene/butadiene latex is preferred for obtaining an excellent balance of binding ability and bending resistance.

This styrene-butadiene latex exists as an aqueous dispersion of a copolymer having a structural unit derived from an aromatic vinyl monomer such as styrene and a structural unit derived from an aliphatic conjugated diene monomer such as 1,3-butadiene. In addition to styrene, examples of the aromatic vinyl monomer include alpha-methylstyrene, vinyl toluene and divinyl benzene, and one or two or more of these may be used. Principally from the standpoint of binding ability, the structural unit derived from the aromatic vinyl monomer may constitute from 20 to 60 mass %, or for example from 30 to 50 mass % of the copolymer.

In addition to 1,3-butadiene, examples of the aliphatic conjugated diene monomer include 2-methyl-1,3-butadiene, 2,3-dimethyl-1,3-butadiene and 2-chloro-1,3-butadiene, and one or two or more of these may be used. Considering the binding ability of the binder and the flexibility of the resulting electrode, the structural unit derived from the aliphatic conjugated diene monomer may constitute from 30 to 70 mass % or for example from 40 to 60 mass % of the copolymer.

Besides the above monomers, a nitrile-containing monomer such as (meth)acrylonitrile, a carboxyl group-containing monomer such as (meth)acrylic acid, itaconic acid or maleic acid, or an ester group-containing monomer such as methyl (meth)acrylate, may be used as a copolymerization monomer, in a styrene/butadiene latex, for the purpose of further improving performance for instance in terms of binding ability.

The structural unit derived from this other monomer may constitute from 0 to 30 mass % or for example from 0 to 20 mass % of the copolymer.

The lithium-sulfur secondary battery electrode mixture layer composition of the present teaching has the above active material, water and binder as essential components, and is obtained by mixing these components by known methods. The method for mixing the components is not particularly limited, and a known method may be adopted, but a method of first dry pressing the active material, a conductive aid, and other powder components including the polymer particle used as the binder, and mixing, dispersing and kneading this with a dispersion medium such as water is preferred. When the electrode mixture layer composition is obtained as a slurry, it is preferably made into an electrode slurry without dispersion defects or aggregations. A known mixer such as a planetary mixer, thin-film spinning mixer or self-rotating mixer may be used as the mixing means, but a thin-film spin mixer is preferred for obtaining a well dispersed state in a short amount of time. When using a thin-film spin mixer, it is desirable to first pre-disperse with an agitator such as a disperser. The viscosity of the slurry may be in the range of from 500 to 10,000 mPa·s for example. Considering the coating properties of the electrode slurry, the maximum viscosity is preferably not more than 7,000 mPa·s, or more preferably not more than 6,000 mPa·s, or still more preferably not more than 5,000 mPa·s, or yet more preferably not more than 4,000 mPa·s, or even more preferably not more than 3,000 mPa·s. The slurry viscosity can be measured at a liquid temperature of 25° C. by the methods described in the examples.

When the lithium-sulfur secondary battery electrode mixture layer composition is obtained as a wet powder, it is preferably kneaded with a Henschel mixer, blender, planetary mixer or twin-screw kneader or the like to obtain a uniform state without concentration irregularities.

<3. Lithium-Sulfur Secondary Battery Electrode and Lithium-Sulfur Secondary Battery>

The secondary battery electrode of the present teaching may be provided with a mixture layer formed from the electrode mixture layer composition of the teaching on the surface of a collector made of copper, aluminum or the like. The mixture layer is formed by first coating the electrode mixture layer composition of the teaching on the surface of the collector, and then drying to remove the water or other solvent. The method for coating the electrode mixture layer composition is not particularly limited, and a known method such as a doctor blade method, dip method, roll coating method, comma coating method, curtain coating method, gravure coating method or extrusion method may be adopted. Drying may also be accomplished by a known method such as hot air blowing, pressure reduction, (far) infrared irradiation, microwave irradiation or the like.

The mixture layer obtained after drying is normally subjected by pressing treatment with a metal press, roll press or the like. The active material and the binder are compacted together by pressing, which can improve the strength of the mixture layer and its adhesiveness with the collector. The thickness of the mixture layer may be adjusted by pressing to about 30% to 80% of the pre-pressed thickness, and the thickness of the mixture layer after pressing is normally about 4 to 200 microns.

A lithium-sulfur secondary battery can be produced by providing a separator and an electrolyte solution in the lithium-sulfur secondary battery electrode of the present teaching. The electrolyte solution may be liquid, a gel or a solid electrolyte such as a polymer electrolyte.

A separator which is disposed between the positive electrode and the negative electrode of the battery plays the role of preventing short circuits caused by contact between the two electrodes, and of holding the electrolyte solution, thereby ensuring ionic conductivity. The separator is preferably a film-like insulating microporous membrane having good ion permeability and good mechanical strength. Concrete materials that can be used include polyolefins such as polyethylene and polypropylene, as well as polytetrafluoroethylene.

As the electrolyte solution there can be used a known ordinarily-used electrolyte solution, depending on the type of the active material.

A nonaqueous electrolyte solution is more preferably used, among electrolyte solutions. As the nonaqueous electrolyte solution there may be used an organic electrolyte solution that is utilized in conventional electrochemical devices; an ionic liquid electrolyte solution may also be used. Known polymer electrolytes such as polyethylene oxide, polyacrylonitrile or polymethyl methacrylate may also be used.

The organic electrolyte solution, which contains an electrolyte salt serving as an ion carrier, is made up of the electrolyte salt, and an organic solvent that dissolves the electrolyte salt.

Examples of the electrolyte salt include salts of group 1 metals and salts of group 2 metals.

Representative examples of salts of group 1 metals include lithium salts, sodium salts and potassium salts, and salts of group 2 metals include magnesium salts and calcium salts.

Examples of anions of the above electrolyte salts include BF₄⁻, NO₃⁻, PF₆⁻, SbF₆⁻, CH₃CH₂OSO₃⁻ and CH₃CO₂⁻; and fluoroalkyl group-containing anions such as CF₃CO₂⁻, CF₃SO₃⁻, (CF₃SO₂)₂N⁻ [bis(trifluoromethylsulfonyl)imide (TFSI)], (FSO₂)₂N^{-[}bis(fluorosulfonyl) imide (FSI), and (CF₃SO₂)₃C⁻.

Concrete examples of the electrolyte salt include lithium salts such as LiClO₄, LiAsF₆, LiPF₆, LiPF₄, LiBF₄, LiB(C₆H₅)₄, LiCl, LiBr, CH₃SO₃Li, LiFSI, LiTFSI and CF₃SO₃Li. Among the foregoing LiFSI is more preferably used.

Examples of the organic solvent include ethers, ketones, lactones, nitriles, amines, amides, sulfur compounds, chlorinated hydrocarbons, esters, carbonates, phosphate ester compounds, sulfolane-based compounds and nitro compounds.

Concrete examples of the organic solvent include ethers such as tetrahydrofuran, 2-methyl tetrahydrofuran, 1,4-dioxane, anisole and 1,2-dimethoxy ethane (DME); ketones such as 4-methyl-2-pentanone; lactones such as γ-butyrolactone; nitriles such as acetonitrile, propionitrile, butyronitrile, valeronitrile and benzonitrile; chlorinated hydrocarbons such as 1,2-dichloroethane; esters such as methylformate; carbonates such as ethylene carbonate (EC), propylene carbonate (PC), dimethylcarbonate and diethylcarbonate (DEM); amides such as dimethylformamide and dimethylthioformamide; phosphate ester compounds such as trimethyl phosphate and triethyl phosphate; and sulfolane-based compounds such as dimethylsulfoxide sulfolane and 3-methyl-sulfolane. The above may be used singly or in the form of a mixed solvent.

The following electrolyte solutions can also be used as the organic electrolyte solution. Examples include specifically a mixed solvent resulting from combining a main solvent in the form of DME or DEM, and an auxiliary solvent in the form of 1,3-dioxolane (DOL), EC, PC or ethylmethylsulfone (EMS), which are polar solvents; and a mixed solvent resulting from combining chemical formula “R₁(CH₂CH₂O)ₙR₂” (where n=2 to 10, R₁ is an alkyl group or an alkoxy group, and R₂ is an alkyl group, in particular, a “glyme” in a case where R₁ is an alkoxy group) typified for instance by tetraethylene glycol dimethyl ether (TEGDME), singly or as a main solvent with DOL or the like as an auxiliary solvent.

The “ionic liquid” in the above ionic liquid electrolyte solution signifies a salt that is liquid at 100° C. or below.

Examples of the cation of the ionic liquid include imidazolium, pyridinium, pyrrolidinium, piperidinium, tetraalkylammonium, pyrazolium and tetraalkylphosphonium.

A lithium-sulfur secondary battery is then obtained by accommodating, in a case or the like, a wound or laminated structure of a positive electrode plate and a negative electrode plate partitioned by a separator.

As described above, the electrode slurry containing the lithium-sulfur secondary battery electrode binder disclosed in the present specification is excellent in coating properties and in settling stability, and accordingly is expected to exhibit excellent binding ability with an electrode material in a mixture layer, and in excellent adhesiveness with a collector. Therefore, a lithium-sulfur secondary battery provided with an electrode obtained through the use of the above binder allows ensuring good integrity, and is expected to bring out good durability (cycle characteristics) even after repeated charge and discharge, which makes the battery suitably for instance as a secondary battery for automotive use.

### EXAMPLES

The present teaching is explained in detail below based on examples, but the present teaching is not limited by these examples. Unless otherwise specified, “parts” and “%” indicate mass parts and mass % values.

In the following examples, the carboxyl group-containing polymers (salts) were evaluated by the following methods.

<Measurement of Particle Diameter in an Aqueous Medium (Water-Swollen Particle Diameter)>

Herein 0.25 g of a powder of a carboxyl group-containing polymer salt and 49.75 g of ion-exchanged water are weighed into a 100 cc container, and the container is set in a rotation/revolution stirrer (Awatori Rentaro AR-250, by Thinky Corporation). Stirring (rotation speed 2000 rpm/revolution speed 800 rpm, 7 minutes) and defoaming (rotation speed 2200 rpm /revolution speed 60 rpm, 1 minute) are then carried out, to prepare a hydrogel in which a crosslinked polymer salt is swollen in water.

The particle size distribution of the hydrogel is then measured using a laser diffraction/scattering particle size distribution meter (Microtrac MT-3300EXII by MicrotracBEL Corp.) using ion-exchanged water as a dispersion medium. Upon circulation of an excessive amount of a dispersion medium with respect to the hydrogel, an amount of hydrogel is added that results in appropriate scattered light intensity, such that the shape of the measured particle size distribution becomes stable a few minutes thereafter. Once stability is confirmed, the particle size distribution is measured, to obtain a volume-based median diameter (D50) as a representative value of particle diameter, and a particle size distribution expressed by (volume-based average particle diameter)/(number-based average particle diameter).

<<Production of a Carboxyl Group-Containing Polymer Salt>>

### Production Example 1: Production of Carboxyl Group-Containing Polymer Salt R-1

A reactor equipped with a stirring blade, a thermometer, a reflux condenser and a nitrogen inlet pipe is used herein for polymerization.

Then 567 parts of acetonitrile, 80.0 parts of acrylic acid (hereafter also referred to as “AA”), 20.0 parts of methyl acrylate (water solubility: 6 g/100 g of water, hereafter also referred to as “MA”), 0.9 parts of tritrimethylolpropane diallyl ether (by Osaka Soda Co., Ltd., product name Neoallyl T-20) and triethylamine in an amount equivalent to 1.0 mol % of AA, are charged into the reactor. The interior of the reactor is thoroughly purged with nitrogen, and thereafter the reactor is heated to an internal temperature of 55° C. Once the internal temperature is confirmed to have stabilized at 55° C., 0.040 parts of 2,2′-azobis(2,4-dimethylvaleronitrile) (by Fujifilm Wako Pure Chemical Industries, Ltd., product name “V-65”) are added as a polymerization initiator; this is taken as the polymerization initiation point, since white turbidity is observed in the reaction solution. The monomer concentration is calculated to be 15.0%. Cooling of the reaction solution is initiated after 12 hours from the polymerization initiation point, and once the internal temperature has dropped to 25° C., there are added 41.9 parts of a powder of lithium hydroxide monohydrate (hereafter also referred to as “LiOH·H₂O”). After addition, the mixture is stirred continuously for 12 hours at room temperature, to obtain a slurry-like polymerization reaction solution in which particles of Crosslinked polymer salt R-1 (Li salt, degree of neutralization 90 mol %) are dispersed in a medium. After 12 hours from the initiation of polymerization, the reaction rates of AA and MA are calculated as 97.6% and 96.9%, respectively.

The resulting polymerization reaction solution is centrifuged to precipitate the polymer particles, and a supernatant is removed. A washing operation of re-dispersing the precipitate in acetonitrile having the same mass as the polymerization reaction solution, centrifuging to precipitate the polymer particles, and removing the supernatant, is then repeated twice. The precipitate is collected and dried for 3 hours at 80° C. under reduced pressure to remove volatile components and obtain a powder of Crosslinked polymer salt R-1. Crosslinked polymer salt R-1 is hygroscopic, and hence is stored sealed in a container having water vapor barrier properties. A powder of Crosslinked polymer salt R-1 is subjected to an IR measurement to determine the degree of neutralization based on the intensity ratio of a peak derived from C═O groups of the carboxylic acid and, a peak derived from C═O groups of the carboxylic acid Li salt; the obtained value is 90 mol %, equal to a value calculated from the preparation. The particle diameter in the aqueous medium is 1.4 μm.

### Production Examples 2 to 12 and Comparative Production Examples 1 to 3: Production of Carboxyl Group-Containing Polymer Salts R-2 to R-15

Polymerization reaction solutions containing carboxyl group-containing polymer salts R-2 to R-15 are obtained in the same way as in Production example 1, but herein the preparation amounts of the respective starting materials are as given in Table 1. In all the polymerization reaction solutions, the reaction rate of AA, of the ethylenically unsaturated monomer (B) and of other monomers is 90% or higher after 12 hours from the polymerization initiation point. Table 1 sets out the water solubility of the ethylenically unsaturated monomer (B) and other monomers.

Next, each polymerization reaction solution is subjected to the same operation as in Production example 1, to yield powdery carboxyl group-containing polymer salts R-2 to R-15. Each carboxyl group-containing polymer salt is stored sealed in a container having water vapor barrier properties.

Physical property values of the obtained polymer salts are measured in the same way as in Production example 1. The results are given in Table 1.

TABLE 1

| | | | | Production example • Comparative production example No. | | | | | | | |
|---|---|---|---|---|---|---|---|---|---|---|---|
| | | | | Production | Production | Production | Production | Production | Production | Production | Production |
| | | | | example | example | example | example | example | example | example | example |
| | | | | 1 | 2 | 3 | 4 | 5 | 6 | 7 | 8 |
| Carboxyl group-containing polymer (salt) | | | | R-1 | R-2 | R-3 | R-4 | R-5 | R-6 | R-7 | R-8 |
| Preparation | Monomer (A) | AA | Water solubility: miscible | 80.0 | 80.0 | 80.0 | 80.0 | 97.0 | 90.0 | 60.0 | 80.0 |
| (parts) | Monomer (B) | VIA | Water solubility: 6 (g/100 g of water) | 20.0 | | | | | | | |
| | | EA | Water solubility: 1.5 (g/100 g of water) | | 20.0 | | | | | | |
| | | BA | Water solubility: 0.2 (g/100 g of water) | | | 20.0 | | 3.0 | 10.0 | 40.0 | 20.0 |
| | | PEA | Water solubility: 0.38 (g/100 g of water) | | | | 20.0 | | | | |
| | Other | HEA | Water solubility: miscible | | | | | | | | |
| | monomers | DMAAm | Water solubility: soluble | | | | | | | | |
| | Crosslinkable | T-20 (parts) | | 0.9 | 0.9 | 0.9 | 0.9 | 0.9 | 0.9 | 0.9 | 0.9 |
| | monomer | Use amount (mol %) | | 0.31% | 0.32% | 0.33% | 0.34% | 0.31% | 0.32% | 0.37% | 0.33% |
| | Basic | TEA (mol %) | | 1.0 | 1.0 | 1.0 | 1.0 | 1.0 | 1.0 | 1.0 | 1.0 |
| | compound | AcN | | 567 | 567 | 567 | 567 | 567 | 567 | 567 | 567 |
| | Polymerization | | | | | | | | | | |
| | solvent | V-65 | | 0.040 | 0.040 | 0.040 | 0.040 | 0.040 | 0.040 | 0.040 | 0.040 |
| | Polymerization | | | | | | | | | | |
| | initiator | LiOH•H₂O | | 41.9 | 41.9 | 41.9 | 41.9 | 50.8 | 47.2 | 31.4 | 32.6 |
| | Process | Na₂CO₃ | | | | | | | | | |
| | neutralization | K₂CO₃ | | | | | | | | | |
| Initial monomer concentration (wt %) | | | | 15% | 15% | 15% | 15% | 15% | 15% | 15% | 15% |
| Neutral salt | | Type | | Li | Li | Li | Li | Li | Li | Li | Li |
| | | Degree of nuetralization (mol %) | | 90.0% | 90.0% | 90.0% | 90.0% | 90.0% | 90.0% | 70.0% | 90.0% |
| Water-swollen particle diameter (μ m) | | | | 1.4 | 1.4 | 1.3 | 1.3 | 1.7 | 1.5 | 1.0 | 1.4 |
| | | | | | Production example • Comparative production example No. | | | | | | |
| | | | | | Production | Production | Production | Production | Comparative | Comparative | Comparative |
| | | | | | example | example | example | example | production | production | production |
| | | | | | 9 | 10 | 11 | 12 | example 1 | example 2 | example 3 |
| | Carboxyl group-containing polymer (salt) | | | | R-9 | R-10 | R-11 | R-12 | R-13 | R-14 | R-15 |
| | Preparation | Monomer (A) | AA | Water solubility: miscible | 80.0 | 80.0 | 80.0 | 80.0 | 100.0 | 80.0 | 80.0 |
| | (parts) | Monomer (B) | VIA | Water solubility: 6 (g/100 g of water) | | | | | | | |
| | | | EA | Water solubility: 1.5 (g/100 g of water) | | | | | | | |
| | | | BA | Water solubility: 0.2 (g/100 g of water) | 20.0 | 20.0 | 10.0 | 20.0 | | | |
| | | | PEA | Water solubility: 0.38 (g/100 g of water) | | | | | | | |
| | | Other | HEA | Water solubility: miscible | | | 10.0 | | | 20.0 | |
| | | monomers | DMAAm | Water solubility: soluble | | | | | | | 20.0 |

| | | | | | | | | |
|---|---|---|---|---|---|---|---|---|
| Crosslinkable | T-20 (parts) | 0.9 | 0.9 | 0.9 | 0.9 | 0.9 | 0.9 | 0.9 |
| monomer | Use amount (mol %) | 0.33% | 0.33% | 0.33% | 0.00% | 0.30% | 0.33% | 0.33% |
| Basic | TEA (mol %) | 1.0 | 1.0 | 1.0 | 1.0 | 1.0 | 1.0 | 1.0 |
| compound | AcN | 567 | 567 | 567 | 567 | 567 | 567 | 567 |
| Polymerization | | | | | | | | |
| solvent | V-65 | 0.040 | 0.040 | 0.040 | 0.040 | 0.040 | 0.040 | 0.040 |
| Polymerization | | | | | | | | |
| initiator | LiOH•H₂O | | | 41.9 | 41.9 | 52.4 | 41.9 | 41.9 |
| Process | Na₂CO₃ | | 53.5 | | | | | |
| neutralization | K₂CO₃ | | | 69.4 | | | | |

| Initial monomer concentration (wt %) | | 15% | 15% | 15% | 15% | 15% | 15% | 15% |
|---|---|---|---|---|---|---|---|---|
| Neutral salt | Type | Na | K | Li | Li | Li | Li | Li |
| | Degree of nuetralization (mol %) | 90.0% | 90.0% | 90.0% | 90.0% | 90.0% | 90.0% | 90.0% |

| | | | | | | | |
|---|---|---|---|---|---|---|---|
| Water-swollen particle diameter (μ m) | 1.3 | 1.3 | 0.9 | Dissolution | 1.7 | 0.9 | 1.7 |

Details on the compounds used in Table 1 are as follows.
AA: Acrylic acid
MA: Methyl acrylate
EA: Ethyl acrylate
BA: n-butyl acrylate
PEA: Phenoxyethyl acrylate (by Osaka Organic Chemical Industry Co., Ltd., product name “Viscoat # 192”)
HEA: 2-hydroxyethyl acrylate
DMAAm: N,N-dimethylacrylamide
T-20: Trimethylolpropane diallyl ether (by Osaka Soda Co., Ltd., product name “Neoallyl T-20”)
TEA: Triethylamine
AcN: Acetonitrile
V-65: 2,2′-azobis (2,4-dimethylvaleronitrile) (by Fujifilm Wako Pure Chemical Industries, Ltd., product name “V-65”)
LiOH•H₂O: Lithium hydroxide monohydrate
Na₂CO₃: Sodium carbonate
K₂CO₃: Potassium carbonate

### Example 1

An electrode is produced using Carboxyl group-containing polymer salt R-1, and is evaluated. The concrete procedures, evaluation methods and so forth are explained below.

(Preparation of an Electrode Mixture Layer Composition (Electrode Slurry))

Sulfur (by Sigma Aldrich, colloidal sulfur powder) is used as the positive electrode active material. Acetylene black (DENKA BLACK Li-400, by Denka Co., Ltd.) is used as a conductive aid.

After thorough mixing beforehand to a mass ratio of sulfur:acetylene black:R-1=100:5:3.2 (solids), using water as a dilution solvent, to a solids concentration that allowed for electrode slurry application, pre-dispersion is carried out using a Disper through addition of ion-exchanged water. This is followed by main dispersion for 15 seconds at a peripheral speed of 20 m/sec using a thin-film spin mixer (FM-56-30, by Primix Corporation), to prepare an electrode slurry for a positive electrode.

The amount of water added as a dilution solvent is appropriately adjusted so that the electrode slurry has a viscosity of about 1,000 to 10,000 mPa·s at a shear rate of 60 s⁻¹. The viscosity of the electrode slurry is measured using a respective carboxyl group-containing polymer salt as the binder.

<Measurement of the Viscosity of the Electrode Slurry>

The viscosity of the positive electrode mixture slurry obtained above is found to be 3,600 mPa·s when measured using an Anton Paar rheometer (Physica MCR301) with a CP25-5 cone plate (diameter 25 mm, cone angle 5°) at a shear rate of 60 s⁻¹ at 25° C.

<Evaluation of the Coating Properties of the Electrode Slurry>

Next, the electrode slurry is applied onto a 20-μm thick aluminum foil using a variable applicator, and is dried overnight at 70° C. in a ventilation dryer, to thereby form a mixture layer. The mixture layer is thereafter rolled to a thickness of 80±5 μm and a packing density of 1.10±0.10 g/cm³, to obtain a positive electrode plate.

(Criteria for Determining Coating Properties)

The electrode slurry obtained above is applied onto an aluminum foil and is dried, after which the appearance of the mixture layer is observed visually, and the coating properties are evaluated in accordance with the determination criteria below (acceptance level: rating B or higher); the results yielded a rating B.
A: No abnormalities in appearance, such as streak unevenness or inclusions, are observable on the surface.
B: Appearance abnormalities, such as streak unevenness or inclusions, are slightly observable on the surface.
C: Appearance abnormalities, such as streak unevenness or inclusions, are prominently observable on the surface.

<Settling Stability of the Electrode Slurry>

There are measured the solids concentration in the supernatant immediately after the electrode slurry is prepared, and the solid concentration in the supernatant after the electrode slurry is allowed to stand at 25° C. for one week.

The method for measuring the solids concentration is described below.

About 0.5 g of the supernatant immediately following production of the electrode slurry, and of the supernatant after the electrode slurry is allowed to stand at 25° C. for 1 week, are sampled in a respective weighing bottle whose mass has been measured beforehand [mass of weighing bottle=B (g)], and the whole is accurately weighed together with the weighing bottle [W₀(g)], after which each sample is accommodated, together with the bottle, in a windless dryer and is dried for 45 minutes at 155° C.; the mass at that point in time is measured together with the weighing bottle [W₁ (g)], and the solids concentration is worked out in accordance with the expression below.

Solids concentration(mass %)=(W₁−B)/(W₀−B)×100

The rate of change of supernatant solids concentration is worked out in accordance with the expression below, and settling stability is evaluated on the basis of the criteria below (acceptance level: rating B or higher). The rate of change (%) in the supernatant solids concentration is 14.3%, which ranked as B.

Rate of change (%) of supernatant solids concentration=100−(supernatant solids concentration after standing for one week)/(supernatant solids concentration immediately following production)×100

(Criteria of Settling Stability)
A: Rate of change of supernatant solids concentration lower than 10%
B: Rate of change of supernatant solids concentration from 10% to less than 20%
C: Rate of change of supernatant solids concentration of 20% or higher

When the active material in the electrode slurry settles, the concentration of the active material in the solids of the supernatant drops, and as a result there increases the rate of change in the supernatant solids concentration.

### Examples 2 to 12 and Comparative Examples 1 to 3

Electrode slurries are prepared by performing the same operations as in Example 1, to yield respective positive electrode plates, but herein the carboxyl group-containing polymer salt that is used as the binder is as given in Table 2. Slurry viscosity, coating properties and settling stability are evaluated. The results are given in Table 2.

TABLE 2

| | | | | Example • Comparative example No. | | | | | | | |
|---|---|---|---|---|---|---|---|---|---|---|---|
| | | | | Exam- | Exam- | Exam- | Exam- | Exam- | Exam- | Exam- | Exam- |
| | | | | ple | ple | ple | ple | ple | ple | ple | ple |
| | | | | 1 | 2 | 3 | 4 | 5 | 6 | 7 | 8 |
| Electrode | Active material | Sulfur | Parts | 100 | 100 | 100 | 100 | 100 | 100 | 100 | 100 |
| mixture layer | Binder | Carboxyl group- | Type | R-1 | R-2 | R-3 | R-4 | R-5 | R-6 | R-7 | R-8 |
| composition | | containing polymer | Parts | 3.2 | 3.2 | 3.2 | 3.2 | 3.2 | 3.2 | 3.2 | 3.2 |
| (electrode | | (salt) | | | | | | | | | |
| slurry) | Conductive aid | Acetylene black | Parts | 5.0 | 5.0 | 5.0 | 5.0 | 5.0 | 5.0 | 5.0 | 5.0 |
| | Solvent | Water | Parts | 132.2 | 108.2 | 108.2 | 108.2 | 132.2 | 108.2 | 108.2 | 108.2 |
| | Solids concentration (mass %) | | | 45% | 50% | 50% | 50% | 45% | 50% | 50% | 50% |
| Evaluation | Electrode slurry viscosity (mPa•s) | | | 3,600 | 8,800 | 4,500 | 6,800 | 8,300 | 6,500 | 2,800 | 7,300 |
| results | Coating properties | | | B | A | A | A | B | A | B | A |
| | Settling stability | Rate of change of | | 14.3 | 3.2 | 0.3 | 0.5 | 12.3 | 2.1 | 7.5 | 3.2 |
| | | supernatant solids (%) | | | | | | | | | |
| | | Rating | | B | A | A | A | B | A | A | A |
| | | | | | Example • Comparative example No. | | | | | | |
| | | | | | | | | | Com- | Com- | Com- |
| | | | | | | | | | para- | para- | para- |
| | | | | | | | | | tive | tive | tive |
| | | | | | Exam- | Exam- | Exam- | Exam- | exam- | exam- | exam- |
| | | | | | ple | ple | ple | ple | ple | ple | ple |
| | | | | | 9 | 10 | 11 | 12 | 1 | 2 | 3 |
| | Electrode | Active material | Sulfur | Parts | 100 | 100 | 100 | 100 | 100 | 100 | 100 |
| | mixture layer | Binder | Carboxyl group- | Type | R-9 | R-10 | R-11 | R-12 | R-13 | R-14 | R-15 |
| | composition | | containing | Parts | 3.2 | 3.2 | 3.2 | 3.2 | 3.2 | 3.2 | 3.2 |
| | (electrode | | polymer (salt) | | | | | | | | |
| | slurry) | Conductive aid | Acetylene black | Parts | 5.0 | 5.0 | 5.0 | 5.0 | 5.0 | 5.0 | 5.0 |
| | | Solvent | Water | Parts | 108.2 | 108.2 | 108.2 | 88.5 | 200.9 | 162.3 | 162.3 |

| | Solids concentration (mass %) | | 50% | 50% | 50% | 55% | 35% | 40% | 40% |
|---|---|---|---|---|---|---|---|---|---|
| Evaluation | Electrode slurry viscosity (mPa•s) | | 3,600 | 3,300 | 7,400 | 2,100 | 3,500 | 2,700 | 3,500 |
| results | Coating properties | | A | A | A | B | C | C | C |
| | Settling | Rate of change of | 0.8 | 1.5 | 1.0 | 17.3 | 37.6 | 28.3 | 25.6 |
| | stability | supernatant solids (%) | | | | | | | |
| | | Rating | A | A | A | B | C | C | C |

As the results of Examples 1 to 12 reveal, the lithium-sulfur secondary battery electrode mixture layer composition (electrode slurry) containing the lithium-sulfur secondary battery electrode binder of the present teaching exhibit excellent coating properties and settling stability. Focusing on the solubility of monomer (B) in 100 g of water at 20° C., even better results of settling stability of the electrode slurry are obtained, among the compositions, in a case where the above solubility is 2 g or less ((Examples 2 to 4). When focusing on the presence or absence of polymer crosslinking, the settling stability of an electrode slurry that contains a crosslinked polymer (Example 3) is superior to that of the non-crosslinked polymer (Example 12).

In a case by contrast where there is used a polymer salt containing no structural unit derived from the ethylenically unsaturated monomer (B) (Comparative examples 1 to 3), the results concerning coating properties and settling stability of the electrode slurry containing the polymer salt are significantly worse than those in the Examples.

### INDUSTRIAL APPLICABILITY

The electrode slurry containing the lithium-sulfur secondary battery electrode binder of the present teaching is excellent in coating properties and in settling stability, and accordingly is expected to exhibit excellent binding ability with an electrode material in an electrode mixture layer, and excellent adhesiveness with a collector. Therefore, a lithium-sulfur secondary battery provided with an electrode obtained through the use of the above binder allows ensuring good integrity, and is expected to bring out good durability (cycle characteristics), even after repeated charge and discharge, and also to contribute to higher capacity secondary batteries for automotive use.

1. A lithium-sulfur secondary battery electrode binder comprising a carboxyl group-containing polymer or salt thereof,
wherein the carboxyl group-containing polymer contains a structural unit derived from an ethylenically unsaturated carboxylic acid monomer (A) and a structural unit derived from an ethylenically unsaturated monomer (B) (excluding monomers classified as (A)), and
the ethylenically unsaturated monomer (B) has a solubility of 10 g or less in 100 g of water at 20° C.

2. The lithium-sulfur secondary battery electrode binder according to claim 1, wherein the carboxyl group-containing polymer contains from 1.0 mass % to 50 mass % of the structural unit derived from the ethylenically unsaturated monomer (B) with respect to all the structural units of the carboxyl group-containing polymer.

3. The lithium-sulfur secondary battery electrode binder according to claim 1, wherein the carboxyl group-containing polymer contains from 50 mass % to 99.9 mass % of the structural unit derived from the ethylenically unsaturated carboxylic acid monomer (A) with respect to all the structural units of the carboxyl group-containing polymer.

4. The lithium-sulfur secondary battery electrode binder according to claim 1, wherein the carboxyl group-containing polymer is a crosslinked polymer.

5. The lithium-sulfur secondary battery electrode binder according to claim 4, wherein the crosslinked polymer is a crosslinked polymer obtained through polymerization of a monomer composition that includes a non-crosslinkable monomer and a crosslinkable monomer.

6. The lithium-sulfur secondary battery electrode binder according to claim 5, wherein a use amount of the crosslinkable monomer is from 0.1 mol % to 2.0 mol % relative to a total amount of the non-crosslinkable monomer.

7. The lithium-sulfur secondary battery electrode binder according to claim 5, wherein the crosslinkable monomer contains a compound having two or more allyl ether groups in the molecule.

8. The lithium-sulfur secondary battery electrode binder according to claim 4, wherein a particle diameter of the crosslinked polymer or salt thereof, measured in an aqueous medium after neutralization to a degree of neutralization from 80 to 100 mol %, is from 0.1 μm to 7.0 μm as a volume-based median diameter.

9. The lithium-sulfur secondary battery electrode binder according to claim 1, which is used for producing a positive electrode of a lithium-sulfur secondary battery.

10. A lithium-sulfur secondary battery electrode mixture layer composition, comprising: the lithium-sulfur secondary battery electrode binder of claim 1, an active material, and water.

11. The lithium-sulfur secondary battery electrode mixture layer composition of claim 10, wherein the active material contains elemental sulfur or a sulfur-based compound.

12. A lithium-sulfur secondary battery electrode, comprising, on a collector surface, a mixture layer formed from the secondary battery electrode mixture layer composition of claim 10.
